(19) United States
(12) Patent Application Publication
(10) Pub. No.: US 2022/0066698 A1
(43) Pub. Date: Mar. 3, 2022

(54) EFFICIENT COMMAND SCHEDULING FOR MULTIPLE MEMORIES

(71) Applicant: Micron Technology, Inc., Boise, ID (US)

(72) Inventors: Chinnakrishnan Ballapuram, San Jose, CA (US); Saira Samar Malik, Lafayette, IN (US); Taeksang Song, San Jose, CA (US)

(21) Appl. No.: 17/395,300

(22) Filed: Aug. 5, 2021

Related U.S. Application Data
(60) Provisional application No. 63/070,388, filed on Aug. 26, 2020.

(51) Int. Cl. G06F 3/06

(52) U.S. Cl. CPC G06F 3/0659; G06F 3/0679; G06F 3/0625; G06F 3/0656

(57) ABSTRACT

Methods, systems, and devices for efficient command scheduling for multiple memories are described. A device may be coupled with a non-volatile memory that may operate as main memory and a volatile memory that may operate as a cache for the non-volatile memory. The device may receive an access command from a host device. The device may determine the appropriate memory from multiple memories for servicing the access command and communicate the access command to the memory.

### CROSS REFERENCE

The present Application for Patent claims the benefit of U.S. Provisional Patent Application No. 63/070,388 by BALLAPURAM et al., entitled “EFFICIENT COMMAND SCHEDULING FOR MULTIPLE MEMORIES,” filed Aug. 26, 2020, assigned to the assignee hereof, and expressly incorporated by reference herein.

### BACKGROUND

The following relates generally to one or more memory systems and more specifically to efficient command scheduling for multiple memories.

Memory devices are widely used to store information in various electronic devices such as computers, wireless communication devices, cameras, digital displays, and the like. Information is stored by programing memory cells within a memory device to various states. For example, binary memory cells may be programmed to one of two supported states, often denoted by a logic 1 or a logic 0. In some examples, a single memory cell may support more than two states, any one of which may be stored. To access the stored information, a component may read, or sense, at least one stored state in the memory device. To store information, a component may write, or program, the state in the memory device.

Various types of memory devices and memory cells exist, including magnetic hard disks, random access memory (RAM), read-only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), flash memory, phase change memory (PCM), self-selecting memory, chalcogenide memory technologies, and others. Memory cells may be volatile or non-volatile. Non-volatile memory, e.g., FeRAM, may maintain their stored logic state for extended periods of time even in the absence of an external power source. Volatile memory devices, e.g., DRAM, may lose their stored state when disconnected from an external power source.

### BRIEF DESCRIPTION OF THE DRAWINGS

FIG. 1 illustrates an example of a system that supports efficient command scheduling for multiple memories in accordance with examples as disclosed herein.

FIG. 2 illustrates an example of a memory subsystem that supports efficient command scheduling for multiple memories in accordance with examples as disclosed herein.

FIG. 3 illustrates an example of a device that supports efficient command scheduling for multiple memories in accordance with examples as disclosed herein.

FIG. 4 illustrates an example of a process flow that supports efficient command scheduling for multiple memories in accordance with examples as disclosed herein.

FIG. 5 shows a block diagram of a device that supports efficient command scheduling for multiple memories in accordance with aspects of the present disclosure.

FIGS. 6 and 7 show flowcharts illustrating a method or methods that support efficient command scheduling for multiple memories in accordance with examples as disclosed herein.

### DETAILED DESCRIPTION

A device, such as an electronic device, may include a non-volatile memory that serves as a main memory (e.g., a primary memory for storing information among other operations) and a volatile memory that serves as a cache. Such a configuration may allow the device to benefit from various advantages of non-volatile memory (e.g., non-volatility, high storage capacity, low power consumption) while maintaining compatibility with other devices, such as a host device. A host device that wishes to access data in the device, however, may not know which memory of multiple stores the data. To ensure that an access command is serviced and ultimately satisfied (e.g., ultimately performed, ultimately executed), a host device may send an access command to both the volatile memory and the non-volatile memory. But sending an access command to multiple memories may consume excess power and may require additional processing resources and bandwidth, among other disadvantages.

According to the techniques described herein, as an alternative to transmitting an access command to multiple memories, a controller in the device may be configured to route an access command from the host device to the appropriate memory. Because the controller routes the access command to the appropriate memory, the servicing and satisfaction of the access command may be ensured without requiring sending the access command to multiple memories. Thus, the device may conserve power and may use fewer processing resources or bandwidth (or both), among other advantages.

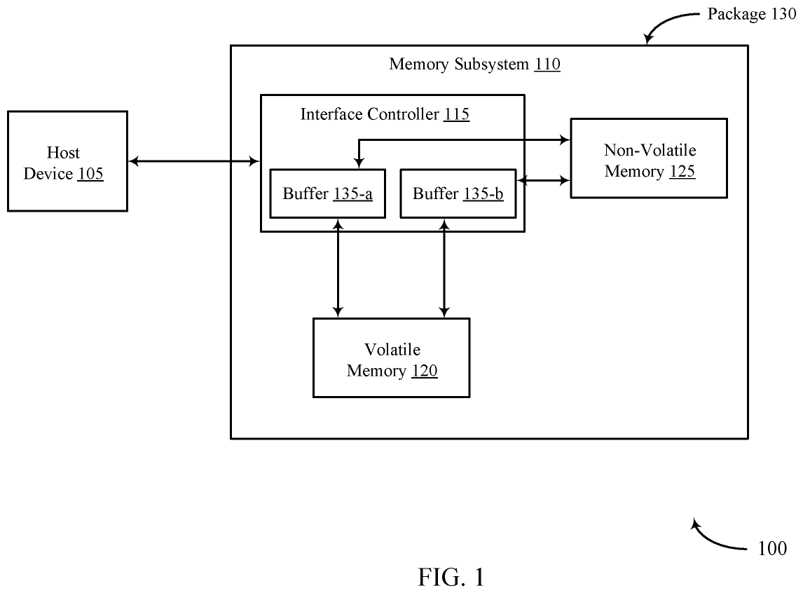

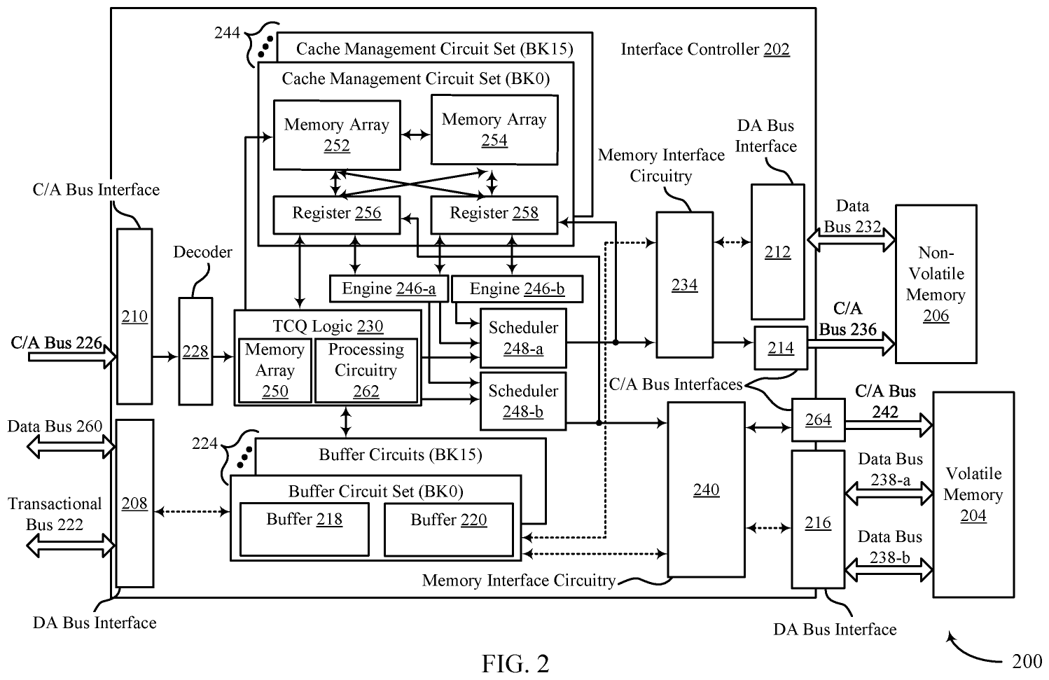

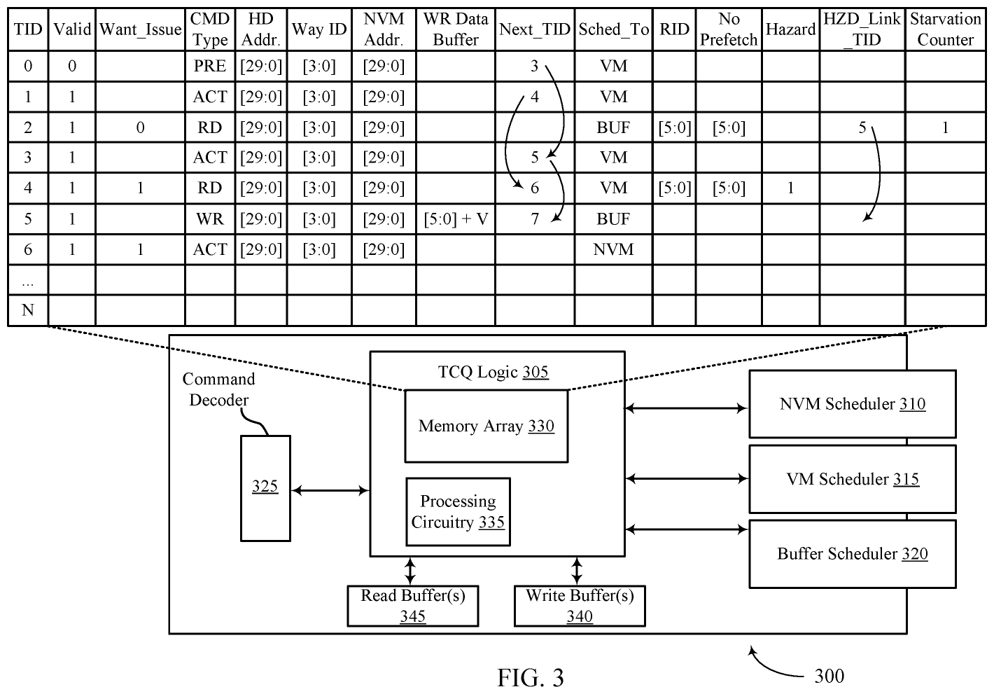

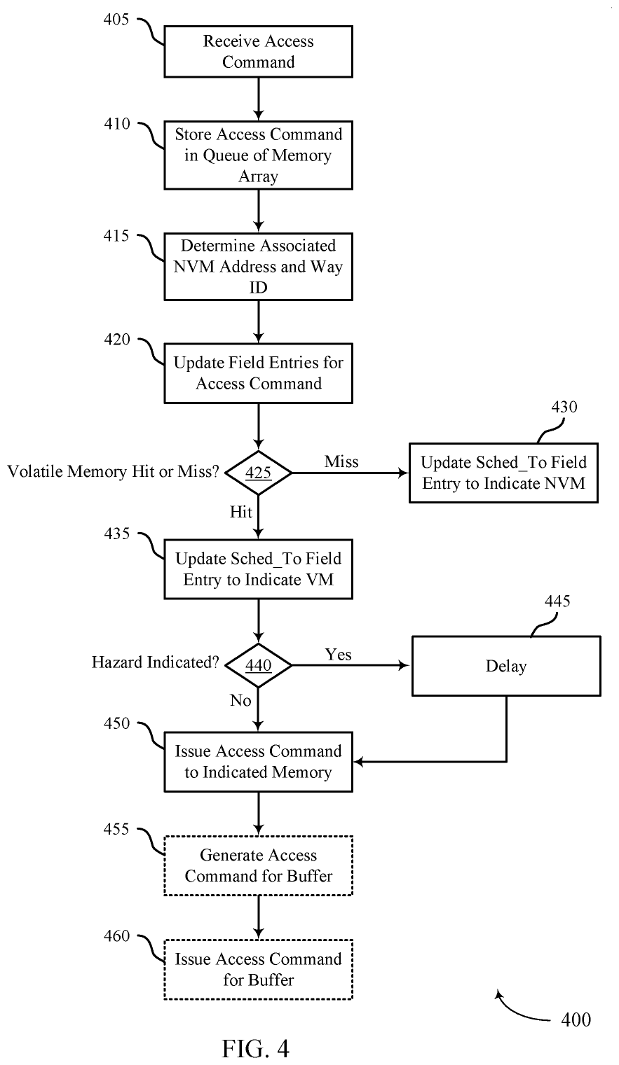

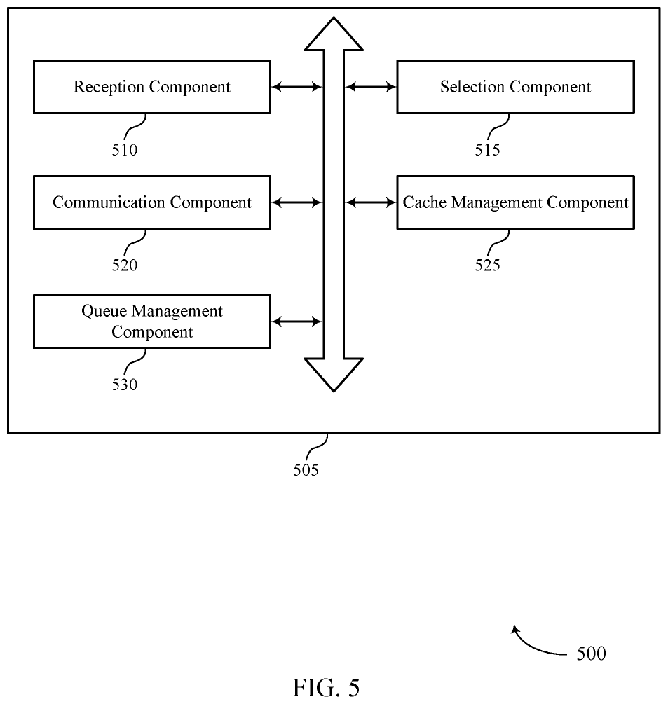

Features of the disclosure are initially described in the context of a memory system and subsystem as described with reference to FIGS. 1 and 2. Features of the disclosure are described in the context a device and process flow as described with reference to FIGS. 3 and 4. These and other features of the disclosure are further illustrated by and described with reference to an apparatus diagram and flowcharts that relate to efficient command scheduling for multiple memories as described with reference to FIGS. 5-7.

FIG. 1 illustrates an example of a memory system 100 that efficient command scheduling for multiple memories in accordance with examples as disclosed herein. The memory system 100 may be included in an electronic device such a computer or phone. The memory system 100 may include a host device 105 and a memory subsystem 110. The host device 105 may be a processor or system-on-a-chip (SoC) that interfaces with the interface controller 115 as well as other components of the electronic device that includes the memory system 100. The memory subsystem 110 may store and provide access to electronic information (e.g., digital information, data) for the host device 105. The memory subsystem 110 may include an interface controller 115, a volatile memory 120, and a non-volatile memory 125. In some examples, the interface controller 115, the volatile memory 120, and the non-volatile memory 125 may be included in a same physical package such as a package 130. However, the interface controller 115, the volatile memory 120, and the non-volatile memory 125 may be disposed on different, respective dies (e.g., silicon dies).

The devices in the memory system 100 may be coupled by various conductive lines (e.g., traces, printed circuit board (PCB) routing, redistribution layer (RDL) routing) that may enable the communication of information (e.g., commands, addresses, data) between the devices. The conductive lines may make up channels, data buses, command buses, address buses, and the like.

The memory subsystem 110 may be configured to provide the benefits of the non-volatile memory 125 while maintaining compatibility with a host device 105 that supports protocols for a different type of memory, such as the volatile memory 120, among other examples. For example, the non-volatile memory 125 may provide benefits (e.g., relative to the volatile memory 120) such as non-volatility, higher capacity, or lower power consumption. But the host device 105 may be incompatible or inefficiently configured with various aspects of the non-volatile memory 125. For instance, the host device 105 may support voltages, access latencies, protocols, page sizes, etc. that are incompatible with the non-volatile memory 125. To compensate for the incompatibility between the host device 105 and the non-volatile memory 125, the memory subsystem 110 may be configured with the volatile memory 120, which may be compatible with the host device 105 and serve as a cache for the non-volatile memory 125. Thus, the host device 105 may use protocols supported by the volatile memory 120 while benefitting from the advantages of the non-volatile memory 125.

In some examples, the memory system 100 may be included in, or coupled with, a computing device, electronic device, mobile computing device, or wireless device. The device may be a portable electronic device. For example, the device may be a computer, a laptop computer, a tablet computer, a smartphone, a cellular phone, a wearable device, an internet-connected device, or the like. In some examples, the device may be configured for bi-directional wireless communication via a base station or access point. In some examples, the device associated with the memory system 100 may be capable of machine-type communication (MTC), machine-to-machine (M2M) communication, or device-to-device (D2D) communication. In some examples, the device associated with the memory system 100 may be referred to as a user equipment (UE), station (STA), mobile terminal, or the like.

The host device 105 may be configured to interface with the memory subsystem 110 using a first protocol (e.g., low-power double data rate (LPDDR)) supported by the interface controller 115. Thus, the host device 105 may, in some examples, interface with the interface controller 115 directly and the non-volatile memory 125 and the volatile memory 120 indirectly. In alternative examples, the host device 105 may interface directly with the non-volatile memory 125 and the volatile memory 120. The host device 105 may also interface with other components of the electronic device that includes the memory system 100. The host device 105 may be or include an SoC, a general-purpose processor, a digital signal processor (DSP), an application-specific integrated circuit (ASIC), a field-programmable gate array (FPGA) or other programmable logic device, discrete gate or transistor logic, discrete hardware components, or it may be a combination of these types of components. In some examples, the host device 105 may be referred to as a host.

The interface controller 115 may be configured to interface with the volatile memory 120 and the non-volatile memory 125 on behalf of the host device 105 (e.g., based on one or more commands or requests issued by the host device 105). For instance, the interface controller 115 may facilitate the retrieval and storage of data in the volatile memory 120 and the non-volatile memory 125 on behalf of the host device 105. Thus, the interface controller 115 may facilitate data transfer between various subcomponents, such as between at least some of the host device 105, the volatile memory 120, or the non-volatile memory 125. The interface controller 115 may interface with the host device 105 and the volatile memory 120 using the first protocol and may interface with the non-volatile memory 125 using a second protocol supported by the non-volatile memory 125.

The non-volatile memory 125 may be configured to store digital information (e.g., data) for the electronic device that includes the memory system 100. Accordingly, the non-volatile memory 125 may include an array or arrays of memory cells and a local memory controller configured to operate the array(s) of memory cells. In some examples, the memory cells may be or include FeRAM cells (e.g., the non-volatile memory 125 may be FeRAM). The non-volatile memory 125 may be configured to interface with the interface controller 115 using the second protocol that is different than the first protocol used between the interface controller 115 and the host device 105. In some examples, the non-volatile memory 125 may have a longer latency for access operations than the volatile memory 120. For example, retrieving data from the non-volatile memory 125 may take longer than retrieving data from the volatile memory 120. Similarly, writing data to the non-volatile memory 125 may take longer than writing data to the volatile memory 120. In some examples, the non-volatile memory 125 may have a smaller page size than the volatile memory 120, as described herein.

The volatile memory 120 may be configured to operate as a cache for one or more components, such as the non-volatile memory 125. For example, the volatile memory 120 may store information (e.g., data) for the electronic device that includes the memory system 100. Accordingly, the volatile memory 120 may include an array or arrays of memory cells and a local memory controller configured to operate the array(s) of memory cells. In some examples, the memory cells may be or include DRAM cells (e.g., the volatile memory may be DRAM). The non-volatile memory 125 may be configured to interface with the interface controller 115 using the first protocol that is used between the interface controller 115 and the host device 105.

In some examples, the volatile memory 120 may have a shorter latency for access operations than the non-volatile memory 125. For example, retrieving data from the volatile memory 120 may take less time than retrieving data from the non-volatile memory 125. Similarly, writing data to the volatile memory 120 may take less time than writing data to the non-volatile memory 125. In some examples, the volatile memory 120 may have a larger page size than the non-volatile memory 125. For instance, the page size of volatile memory 120 may be 2 kilobytes (2 kB) and the page size of non-volatile memory 125 may be 64 bytes (64 B) or 128 bytes (128 B).

Although the non-volatile memory 125 may be a higher-density memory than the volatile memory 120, accessing the non-volatile memory 125 may take longer than accessing the volatile memory 120 (e.g., due to different architectures and protocols, among other reasons). Accordingly, operating the volatile memory 120 as a cache may reduce latency in the memory system 100. As an example, an access request for data from the host device 105 may be satisfied relatively quickly by retrieving the data from the volatile memory 120 rather than from the non-volatile memory 125. To facilitate operation of the volatile memory 120 as a cache, the interface controller 115 may include multiple buffers 135. The buffers 135 may be disposed on the same die as the interface controller 115 and may be configured to temporarily store data for transfer between the volatile memory 120, the non-volatile memory 125, or the host device 105 (or any combination thereof) during one or more access operations (e.g., storage and retrieval operations).

An access operation may also be referred to as an access process or access procedure and may involve one or more sub-operations that are performed by one or more of the components of the memory subsystem 110. Examples of access operations may include storage operations in which data provided by the host device 105 is stored (e.g., written to) in the volatile memory 120 or the non-volatile memory 125 (or both), and retrieval operations in which data requested by the host device 105 is obtained (e.g., read) from the volatile memory 120 or the non-volatile memory 125 and is returned to the host device 105.

To store data in the memory subsystem 110, the host device 105 may initiate a storage operation (or “storage process”) by transmitting a storage command (also referred to as a storage request, a write command, or a write request) to the interface controller 115. The storage command may target a set of non-volatile memory cells in the non-volatile memory 125. In some examples, a set of memory cells may also be referred to as a portion of memory. The host device 105 may also provide the data to be written to the set of non-volatile memory cells to the interface controller 115. The interface controller 115 may temporarily store the data in the buffer 135-a. After storing the data in the buffer 135-a, the interface controller 115 may transfer the data from the buffer 135-a to the volatile memory 120 or the non-volatile memory 125 or both. In write-through mode, the interface controller 115 may transfer the data to both the volatile memory 120 and the non-volatile memory 125. In write-back mode, the interface controller 115 may only transfer the data to the volatile memory 120.

In either mode, the interface controller 115 may identify an appropriate set of one or more volatile memory cells in the volatile memory 120 for storing the data associated with the storage command. To do so, the interface controller 115 may implement set-associative mapping in which each set (e.g., block) of one or more non-volatile memory cells in the non-volatile memory 125 may be mapped to multiple sets of volatile memory cells in the volatile memory 120. For instance, the interface controller 115 may implement n-way associative mapping which allows data from a set of non-volatile memory cells to be stored in one of n sets of volatile memory cells in the volatile memory 120. Thus, the interface controller 115 may manage the volatile memory 120 as a cache for the non-volatile memory 125 by referencing the n sets of volatile memory cells associated with a targeted set of non-volatile memory cells. As used herein, a “set” of objects may refer to one or more of the objects unless otherwise described or noted. Although described with reference to set-associative mapping, the interface controller 115 may manage the volatile memory 120 as a cache by implementing one or more other types of mapping such as direct mapping or associative mapping, among other examples.

After determining which n sets of volatile memory cells are associated with the targeted set of non-volatile memory cells, the interface controller 115 may store the data in one or more of the n sets of volatile memory cells. This way, a subsequent retrieval command from the host device 105 for the data can be efficiently satisfied by retrieving the data from the lower-latency volatile memory 120 instead of retrieving the data from the higher-latency non-volatile memory 125. The interface controller 115 may determine which of the n sets of the volatile memory 120 to store the data based on one or more parameters associated with the data stored in the n sets of the volatile memory 120, such as the validity, age, or modification status of the data. Thus, a storage command by the host device 105 may be wholly (e.g., in write-back mode) or partially (e.g., in write-through mode) satisfied by storing the data in the volatile memory 120. To track the data stored in the volatile memory 120, the interface controller 115 may store for one or more sets of volatile memory cells (e.g., for each set of volatile memory cells) a tag address that indicates the non-volatile memory cells with data stored in a given set of volatile memory cells.

To retrieve data from the memory subsystem 110, the host device 105 may initiate a retrieval operation (also referred to as a retrieval process) by transmitting a retrieval command (also referred to as a retrieval request, a read command, or a read request) to the interface controller 115. The retrieval command may target a set of one or more non-volatile memory cells in the non-volatile memory 125. Upon receiving the retrieval command, the interface controller 115 may check for the requested data in the volatile memory 120. For instance, the interface controller 115 may check for the requested data in the n sets of volatile memory cells associated with the targeted set of non-volatile memory cells. If one of the n sets of volatile memory cells stores the requested data (e.g., stores data for the targeted set of non-volatile memory cells), the interface controller 115 may transfer the data from the volatile memory 120 to the buffer 135-a (e.g., in response to determining that one of the n sets of volatile memory cells stores the requested data, as described in FIGS. 4 and 5) so that it can be transmitted to the host device 105. The term “hit” may be used to refer to the scenario where the volatile memory 120 stores data requested by the host device 105. If the n sets of one or more volatile memory cells do not store the requested data (e.g., the n sets of volatile memory cells store data for a set of non-volatile memory cells other than the targeted set of non-volatile memory cells), the interface controller 115 may transfer the requested data from the non-volatile memory 125 to the buffer 135-a (e.g., in response to determining that the n sets of volatile memory cells do not store the requested data, as described with reference to FIGS. 4 and 5) so that it can be transmitted to the host device 105. The term “miss” may be used to refer to the scenario where the volatile memory 120 does not store data requested by the host device 105.

In a miss scenario, after transferring the requested data to the buffer 135-a, the interface controller 115 may transfer the requested data from the buffer 135-a to the volatile memory 120 so that subsequent read requests for the data can be satisfied by the volatile memory 120 instead of the non-volatile memory 125. For example, the interface controller 115 may store the data in one of the n sets of volatile memory cells associated with the targeted set of non-volatile memory cells. But the n sets of volatile memory cells may already be storing data for other sets of non-volatile memory cells. So, to preserve this other data, the interface controller 115 may transfer the other data to the buffer 135-b so that it can be transferred to the non-volatile memory 125 for storage. Such a process may be referred to as “eviction” and the data transferred from the volatile memory 120 to the buffer 135-b may be referred to as “victim” data. In some cases, the interface controller 115 may transfer a subset of the victim data from the buffer 135-b to the non-volatile memory 125. For example, the interface controller 115 may transfer one or more subsets of victim data that have changed since the data was initially stored in the non-volatile memory 125. Data that is inconsistent between the volatile memory 120 and the non-volatile memory 125 (e.g., due to an update in one memory and not the other) may be referred to in some cases as “modified” or “dirty” data. In some examples (e.g., when interface controller operates in one mode such as a write-back mode), dirty data may be data that is present in the volatile memory 120 but not present in the non-volatile memory 125.

As noted, the host device 105 may access data stored in the memory subsystem 110 by sending one or more access commands (also referred to herein as “requests”) to the memory subsystem 110. But, when requesting data, the host device 105 may not know which memory (e.g., the volatile memory 120, the non-volatile memory 125, another memory) stores the data. Using other different techniques, to ensure that a request for data is satisfied, the host device 105 may transmit the request to both the volatile memory 120 and the non-volatile memory 125. But transmitting a request to multiple memories using these other different techniques may consume excess power and may require additional processing resources and bandwidth, among other disadvantages.

According to the techniques described herein, transmission of an access command to multiple memories may be avoided by channeling access commands from the host device 105 to a controller, for example, in the interface controller 115. The controller may manage the access commands from the host device 105 based on determining the appropriate memory to service each request and routing that access command to the appropriate memory. As a result, the memory subsystem 110 may conserve power and may use fewer processing resources or bandwidth (or both), among other advantages.

FIG. 2 illustrates an example of a memory subsystem 200 that efficient command scheduling for multiple memories in accordance with examples as disclosed herein. The memory subsystem 200 may be an example of the memory subsystem 110 described with reference to FIG. 1. Accordingly, the memory subsystem 200 may interact with a host device as described with reference to FIG. 1. The memory subsystem 200 may include an interface controller 202, a volatile memory 204, and a non-volatile memory 206, which may be examples of the interface controller 115, the volatile memory 120, and the non-volatile memory 125, respectively, as described with reference to FIG. 1. Thus, the interface controller 202 may interface with the volatile memory 204 and the non-volatile memory 206 on behalf of the host device as described with reference to FIG. 1. For example, the interface controller 202 may operate the volatile memory 204 as a cache for the non-volatile memory 206. Operating the volatile memory 204 as the cache may allow subsystem to provide the benefits of the non-volatile memory 206 (e.g., non-volatile, high-density storage) while maintaining compatibility with a host device that supports a different protocol than the non-volatile memory 206.

In FIG. 2, dashed lines between components represent the flow of data or communication paths for data and solid lines between components represent the flow of commands or communication paths for commands. In some cases, the memory subsystem 200 is one of multiple similar or identical subsystems that may be included in an electronic device. Each subsystem may be referred to as a slice and may be associated with a respective channel of a host device in some examples.

The non-volatile memory 206 may be configured to operate as a main memory (e.g., memory for long-term data storage) for a host device. In some cases, the non-volatile memory 206 may include one or more arrays of FeRAM cells. Each FeRAM cell may include a selection component and a ferroelectric capacitor and may be accessed by applying appropriate voltages to one or more access lines such as word lines, plates lines, and digit lines. In some examples, a subset of FeRAM cells coupled with to an activated word line may be sensed, for example concurrently or simultaneously, without having to sense all FeRAM cells coupled with the activated word line. Accordingly, a page size for an FeRAM array may be different than (e.g., smaller than) a DRAM page size. In the context of a memory device, a page may refer to the memory cells in a row (e.g., a group of the memory cells that have a common row address) and a page size may refer to the number of memory cells or column addresses in a row, or the number of column addresses accessed during an access operation. Alternatively, a page size may refer to a size of data handled by various interfaces. In some cases, different memory device types may have different page sizes. For example, a DRAM page size (e.g., 2 kB) may be a superset of a non-volatile memory (e.g., FeRAM) page size (e.g., 64 B).

A smaller page size of an FeRAM array may provide various efficiency benefits, as an individual FeRAM cell may require more power to read or write than an individual DRAM cell. For example, a smaller page size for an FeRAM array may facilitate effective energy usage because a smaller number of FeRAM cells may be activated when an associated change in information is minor. In some examples, the page size for an array of FeRAM cells may vary, for example dynamically (e.g., during operation of the array of FeRAM cells) depending on the nature of data and command utilizing FeRAM operation.

Although an individual FeRAM cell may require more power to read or write than an individual DRAM cell, an FeRAM cell may maintain its stored logic state for an extended period of time in the absence of an external power source, as the ferroelectric material in the FeRAM cell may maintain a non-zero electric polarization in the absence of an electric field. Therefore, including an FeRAM array in the non-volatile memory 206 may provide efficiency benefits relative to volatile memory cells (e.g., DRAM cells in the volatile memory 204), as it may reduce or eliminate requirements to perform refresh operations.

The volatile memory 204 may be configured to operate as a cache for the non-volatile memory 206. In some cases, the volatile memory 204 may include one or more arrays of DRAM cells. Each DRAM cell may include a capacitor that includes a dielectric material to store a charge representative of the programmable state. The memory cells of the volatile memory 204 may be logically grouped or arranged into one or more memory banks (as referred to herein as “banks”). For example, volatile memory 204 may include sixteen banks. The memory cells of a bank may be arranged in a grid or an array of intersecting columns and rows and each memory cell may be accessed or refreshed by applying appropriate voltages to the digit line (e.g., column line) and word line (e.g., row line) for that memory cell. The rows of a bank may be referred to pages, and the page size may refer to the number of columns or memory cells in a row. As noted, the page size of the volatile memory 204 may be different than (e.g., larger than) the page size of the non-volatile memory 206.

The interface controller 202 may include various circuits for interfacing (e.g., communicating) with other devices, such as a host device, the volatile memory 204, and the non-volatile memory 206. For example, the interface controller 202 may include a data (DA) bus interface 208, a command and address (C/A) bus interface 210, a data bus interface 212, a C/A bus interface 214, a data bus interface 216, and a C/A bus interface 264. The data bus interfaces may support the communication of information using one or more communication protocols. For example, the data bus interface 208, the C/A bus interface 210, the data bus interface 216, and the C/A bus interface 264 may support information that is communicated using a first protocol (e.g., LPDDR signaling), whereas the data bus interface 212 and the C/A bus interface 214 may support information communicated using a second protocol. Thus, the various bus interfaces coupled with the interface controller 202 may support different amounts of data or data rates.

The data bus interface 208 may be coupled with the data bus 260, the transactional bus 222, and the buffer circuitry 224. The data bus interface 208 may be configured to transmit and receive data over the data bus 260 and control information (e.g., acknowledgements/negative acknowledgements) or metadata over the transactional bus 222. The data bus interface 208 may also be configured to transfer data between the data bus 260 and the buffer circuitry 224. The data bus 260 and the transactional bus 222 may be coupled with the interface controller 202 and the host device such that a conductive path is established between the interface controller 202 and the host device. In some examples, the pins of the transactional bus 222 may be referred to as data mask inversion (DMI) pins. Although shown with one data bus 260 and one transactional bus 222, there may be any number of data buses 260 and any number of transactional buses 222 coupled with one or more data bus interfaces 208.

The C/A bus interface 210 may be coupled with the C/A bus 226 and the decoder 228. The C/A bus interface 210 may be configured to transmit and receive commands and addresses over the C/A bus 226. The commands and addresses received over the C/A bus 226 may be associated with data received or transmitted over the data bus 260. The C/A bus interface 210 may also be configured to transmit commands and addresses to the decoder 228 so that the decoder 228 can decode the commands and relay the decoded commands and associated addresses to the transaction command queue (TCQ) logic 230.

The data bus interface 212 may be coupled with the data bus 232 and the memory interface circuitry 234. The data bus interface 212 may be configured to transmit and receive data over the data bus 232, which may be coupled with the non-volatile memory 206. The data bus interface 212 may also be configured to transfer data between the data bus 232 and the memory interface circuitry 234. The C/A bus interface 214 may be coupled with the C/A bus 236 and the memory interface circuitry 234. The C/A bus interface 214 may be configured to receive commands and addresses from the memory interface circuitry 234 and relay the commands and the addresses to the non-volatile memory 206 (e.g., to a local controller of the non-volatile memory 206) over the C/A bus 236. The commands and the addresses transmitted over the C/A bus 236 may be associated with data received or transmitted over the data bus 232. The data bus 232 and the C/A bus 236 may be coupled with the interface controller 202 and the non-volatile memory 206 such that conductive paths are established between the interface controller 202 and the non-volatile memory 206.

The data bus interface 216 may be coupled with the data buses 238 and the memory interface circuitry 240. The data bus interface 216 may be configured to transmit and receive data over the data buses 238, which may be coupled with the volatile memory 204. The data bus interface 216 may also be configured to transfer data between the data buses 238 and the memory interface circuitry 240. The C/A bus interface 264 may be coupled with the C/A bus 242 and the memory interface circuitry 240. The C/A bus interface 264 may be configured to receive commands and addresses from the memory interface circuitry 240 and relay the commands and the addresses to the volatile memory 204 (e.g., to a local controller of the volatile memory 204) over the C/A bus 242. The commands and addresses transmitted over the C/A bus 242 may be associated with data received or transmitted over the data buses 238. The data bus 238 and the C/A bus 242 may be coupled with the interface controller 202 and the volatile memory 204 such that conductive paths are established between the interface controller 202 and the volatile memory 204.

In addition to buses and bus interfaces for communicating with coupled devices, the interface controller 202 may include circuitry for operating the non-volatile memory 206 as a main memory and the volatile memory 204 as a cache. For example, the interface controller 202 may include TCQ logic 230, buffer circuitry 224, cache management circuitry 244, one or more engines 246, and one or more schedulers 248.

The TCQ logic 230 may be coupled with the buffer circuitry 224, the decoder 228, the cache management circuitry 244, and the schedulers 248, among other components. The TCQ logic 230 may be configured to receive command and address information from the decoder 228 and store the command and address information in the memory array 250. The TCQ logic 230 may include processing circuitry 262 that processes command information (e.g., from a host device) and storage information from other components (e.g., the cache management circuitry 244, the buffer circuitry 224) and uses that information to manage or generate one or more commands for the schedulers 248. The TCQ logic 230 may also be configured to transfer address information (e.g., address bits) to the cache management circuitry 244. In some examples, the TCQ logic 230 may include or be coupled with one or more local buffers that may store data for relay between the buffer 218 and the memories (e.g., the volatile memory 204, the non-volatile memory 206). In some examples, the TCQ logic 230 may be coupled with a scheduler (or “arbiter”) for the buffer 218.

The buffer circuitry 224 may be coupled with the data bus interface 208, the TCQ logic 230, the memory interface circuitry 234, and the memory interface circuitry 234. The buffer circuitry 224 may include a set of one or more buffer circuits for at least some banks, if not each bank, of the volatile memory 204. The buffer circuitry 224 may also include components (e.g., a memory controller) for accessing the buffer circuits. In one example, the volatile memory 204 may include sixteen banks and the buffer circuitry 224 may include sixteen sets of buffer circuits. Each set of the buffer circuits may be configured to store data from or for (or both) a respective bank of the volatile memory 204. As an example, the buffer circuit set for bank 0 (BK0) may be configured to store data from or for (or both) the first bank of the volatile memory 204 and the buffer circuit for bank 15 (BK15) may be configured to store data from or for (or both) the sixteenth bank of the volatile memory 204.

Each set of buffer circuits in the buffer circuitry 224 may include a pair of buffers. The pair of buffers may include one buffer (e.g., an open page data (OPD) buffer) configured to store data targeted by an access command (e.g., a storage command or retrieval command) from the host device and another buffer (e.g., a victim page data (VPD) buffer) configured to store data for an eviction process that results from the access command. For example, the buffer circuit set for BK0 may include the buffer 218 and the buffer 220, which may be examples of buffer 135-a and 135-b, respectively. The buffer 218 may be configured to store BK0 data that is targeted by an access command from the host device. And the buffer 220 may be configured to store data that is transferred from BK0 as part of an eviction process triggered by the access command. Each buffer in a buffer circuit set may be configured with a size (e.g., storage capacity) that corresponds to a page size of the volatile memory 204. For example, if the page size of the volatile memory 204 is 2 kB, the size of each buffer may be 2 kB. Thus, the size of the buffer may be equivalent to the page size of the volatile memory 204 in some examples.

The cache management circuitry 244 may be coupled with the TCQ logic 230, the engines 246, and the schedulers 248, among other components. The cache management circuitry 244 may include a cache management circuit set for one or more banks (e.g., each bank) of volatile memory. As an example, the cache management circuitry 244 may include sixteen cache management circuit sets for BK0 through BK15. Each cache management circuit set may include two memory arrays that may be configured to store storage information for the volatile memory 204. As an example, the cache management circuit set for BK0 may include a memory array 252 (e.g., a CDRAM Tag Array (CDT-TA)) and a memory array 254 (e.g., a CDRAM Valid (CDT-V) array), which may be configured to store storage information for BK0. The memory arrays may also be referred to as arrays or buffers in some examples. In some cases, the memory arrays may be or include volatile memory cells, such as SRAM cells.

Storage information may include content information, validity information, or dirty information (or any combination thereof) associated with the volatile memory 204. Content information (which may also be referred to as tag information or address information) may indicate which data is stored in a set of volatile memory cells. For example, the content information (e.g., a tag address) for a set of one or more volatile memory cells may indicate which set of one or more non-volatile memory cells currently has data stored in the set of one or more volatile memory cells. Validity information may indicate whether the data stored in a set of volatile memory cells is actual data (e.g., data having an intended order or form) or placeholder data (e.g., data being random or dummy, not having an intended or important order). And dirty information may indicate whether the data stored in a set of one or more volatile memory cells of the volatile memory 204 is different than corresponding data stored in a set of one or more non-volatile memory cells of the non-volatile memory 206. For example, dirty information may indicate whether data stored in a set of volatile memory cells has been updated relative to data stored in the non-volatile memory 206.

The memory array 252 may include memory cells that store storage information (e.g., content and validity information) for an associated bank (e.g., BK0) of the volatile memory 204. The storage information may be stored on a per-page basis (e.g., there may be respective storage information for each page of the associated non-volatile memory bank).

The interface controller 202 may check for requested data in the volatile memory 204 by referencing the storage information in the memory array 252. For instance, the interface controller 202 may receive, from a host device, a retrieval command for data in a set of non-volatile memory cells in the non-volatile memory 206. The interface controller 202 may use a set of one or more address bits (e.g., a set of row address bits) targeted by the access request to reference the storage information in the memory array 252. For instance, using set-associative mapping, the interface controller 202 may reference the content information in the memory array 252 to determine which set of volatile memory cells, if any, stores the requested data.

In addition to storing content information for volatile memory cells, the memory array 252 may also store validity information that indicates whether the data in a set of volatile memory cells is actual data (also referred to as valid data) or random data (also referred to as invalid data). For example, the volatile memory cells in the volatile memory 204 may initially store random data and continue to do so until the volatile memory cells are written with data from a host device or the non-volatile memory 206. To track which data is valid, the memory array 252 may be configured to set a bit for each set of volatile memory cells when actual data is stored in that set of volatile memory cells. This bit may be referred to a validity bit or a validity flag. As with the content information, the validity information stored in the memory array 252 may be stored on a per-page basis. Thus, each validity bit may indicate the validity of data stored in an associated page in some examples.

The memory array 254 may be similar to the memory array 252 and may also include memory cells that store validity information for a bank (e.g., BK0) of the volatile memory 204 that is associated with the memory array 252. However, the validity information stored in the memory array 254 may be stored on a sub-block basis as opposed to a per-page basis for the memory array 252. For example, the validity information stored in the memory cells of the memory array 254 may indicate the validity of data for subsets of volatile memory cells in a set (e.g., page) of volatile memory cells. As an example, the validity information in the memory array 254 may indicate the validity of each subset (e.g., 64B) of data in a page of data stored in BK0 of the volatile memory 204. Storing content information and validity information on a per-page basis in the memory array 252 may allow the interface controller 202 to quickly and efficiently determine whether there is a hit or miss for data in the volatile memory 204. Storing validity information on a sub-block basis may allow the interface controller 202 to determine which subsets of data to preserve in the non-volatile memory 206 during an eviction process.

Each cache management circuit set may also include a respective pair of registers coupled with the TCQ logic 230, the engines 246, the memory interface circuitry 234, the memory interface circuitry 240, and the memory arrays for that cache management circuit set, among other components. For example, a cache management circuit set may include a first register (e.g., a register 256 which may be an open page tag (OPT) register) configured to receive storage information (e.g., one or more bits of tag information, validity information, or dirty information) from the memory array 252 or the scheduler 248-b or both. The cache management circuitry set may also include a second register (e.g., a register 258 which may be a victim page tag (VPT) register) configured to receive storage information from the memory array 254 and the scheduler 248-a or both. The information in the register 256 and the register 258 may be transferred to the TCQ logic 230 and the engines 246 to enable decision-making by these components. For example, the TCQ logic 230 may issue commands for reading the non-volatile memory 206 or the volatile memory 204 based on content information from the register 256.

The engine 246-a may be coupled with the register 256, the register 258, and the schedulers 248. The engine 246-a may be configured to receive storage information from various components and issue commands to the schedulers 248 based on the storage information. For example, when the interface controller 202 is in a first mode such as a write-through mode, the engine 246-a may issue commands to the scheduler 248-b and in response the scheduler 248-b to initiate or facilitate the transfer of data from the buffer 218 to both the volatile memory 204 and the non-volatile memory 206. Alternatively, when the interface controller 202 is in a second mode such as a write-back mode, the engine 246-a may issue commands to the scheduler 248-b and in response the scheduler 248-b may initiate or facilitate the transfer of data from the buffer 218 to the volatile memory 204. In the event of a write-back operation, the data stored in the volatile memory 204 may eventually be transferred to the non-volatile memory 206 during a subsequent eviction process.

The engine 246-b may be coupled with the register 258 and the scheduler 248-a. The engine 246-b may be configured to receive storage information from the register 258 and issue commands to the scheduler 248-a based on the storage information. For instance, the engine 246-b may issue commands to the scheduler 248-a to initiate or facilitate transfer of dirty data from the buffer 220 to the non-volatile memory 206 (e.g., as part of an eviction process). If the buffer 220 holds a set of data transferred from the volatile memory 204 (e.g., victim data), the engine 246-b may indicate which one or more subsets (e.g., which 64B) of the set of data in the buffer 220 should be transferred to the non-volatile memory 206.

The scheduler 248-a may be coupled with various components of the interface controller 202 and may facilitate accessing the non-volatile memory 206 by issuing commands to the memory interface circuitry 234. The commands issued by the scheduler 248-a may be based on commands from the TCQ logic 230, the engine 246-a, the engine 246-b, or a combination of these components. Similarly, the scheduler 248-b may be coupled with various components of the interface controller 202 and may facilitate accessing the volatile memory 204 by issuing commands to the memory interface circuitry 240. The commands issued by the scheduler 248-b may be based on commands from the TCQ logic 230 or the engine 246-a, or both. In some examples, the schedulers 248 may be referred to as scheduler components, scheduling components, or other suitable terminology, and may be (or include) a circuit, logic, a controller, a processor, etc. capable of performing the functions described herein.

The memory interface circuitry 234 may communicate with the non-volatile memory 206 via one or more of the data bus interface 212 and the C/A bus interface 214. For example, the memory interface circuitry 234 may prompt the C/A bus interface 214 to relay commands issued by the memory interface circuitry 234 over the C/A bus 236 to a local controller in the non-volatile memory 206. And the memory interface circuitry 234 may transmit to, or receive data from, the non-volatile memory 206 over the data bus 232. In some examples, the commands issued by the memory interface circuitry 234 may be supported by the non-volatile memory 206 but not the volatile memory 204 (e.g., the commands issued by the memory interface circuitry 234 may be different than the commands issued by the memory interface circuitry 240).

The memory interface circuitry 240 may communicate with the volatile memory 204 via one or more of the data bus interface 216 and the C/A bus interface 264. For example, the memory interface circuitry 240 may prompt the C/A bus interface 264 to relay commands issued by the memory interface circuitry 240 over the C/A bus 242 to a local controller of the volatile memory 204. And the memory interface circuitry 240 may transmit to, or receive data from, the volatile memory 204 over one or more data buses 238. In some examples, the commands issued by the memory interface circuitry 240 may be supported by the volatile memory 204 but not the non-volatile memory 206 (e.g., the commands issued by the memory interface circuitry 240 may be different than the commands issued by the memory interface circuitry 234).

Together, the components of the interface controller 202 may operate the non-volatile memory 206 as a main memory and the volatile memory 204 as a cache. Such operation may be prompted by one or more access commands (e.g., read/retrieval commands/requests and write/storage commands/requests) received from a host device.

In some examples, the interface controller 202 may receive a storage command from the host device. The storage command may be received over the C/A bus 226 and transferred to the TCQ logic 230 via one or more of the C/A bus interface 210 and the decoder 228. The storage command may include or be accompanied by address bits that target a memory address of the non-volatile memory 206. The data to be stored may be received over the data bus 260 and transferred to the buffer 218 via the data bus interface 208. In a write-through mode, the interface controller 202 may transfer the data to both the non-volatile memory 206 and the volatile memory 204. In a write-back mode, the interface controller 202 may transfer the data to only the volatile memory 204. In either mode, the interface controller 202 may first check to see if the volatile memory 204 has memory cells available to store the data. To do so, the TCQ logic 230 may reference the memory array 252 (e.g., using a set of the memory address bits) to determine whether one or more of the n sets (e.g., pages) of volatile memory cells associated with the memory address are empty (e.g., store random or invalid data). In some cases, a set of volatile memory cells in the volatile memory 204 may be referred to as a line or cache line.

If one of then associated sets of volatile memory cells is available for storing information, the interface controller 202 may transfer the data from the buffer 218 to the volatile memory 204 for storage in that set of volatile memory cells. But if no associated sets of volatile memory cells are empty, the interface controller 202 may initiate an eviction process to make room for the data in the volatile memory 204. The eviction process may involve transferring the old data (e.g., existing data) in one of the n associated sets of volatile memory cells to the buffer 220. The dirty information for the old data may also be transferred to the memory array 254 or register 258 for identification of dirty subsets of the old data. After the old data is stored in the buffer 220, the new data can be transferred from the buffer 218 to the volatile memory 204 and the old data can be transferred from the buffer 220 to the non-volatile memory 206. In some cases, dirty subsets of the old data are transferred to the non-volatile memory 206 and clean subsets (e.g., unmodified subsets) are discarded. The dirty subsets may be identified by the engine 246-b based on dirty information transferred (e.g., from the volatile memory 204) to the memory array 254 or register 258 during the eviction process.

In another example, the interface controller 202 may receive a retrieval command from the host device. The retrieval command may be received over the C/A bus 226 and transferred to the TCQ logic 230 via one or more of the C/A bus interface 210 and the decoder 228. The retrieval command may include address bits that target a memory address of the non-volatile memory 206. Before attempting to access the targeted memory address of the non-volatile memory 206, the interface controller 202 may check to see if the volatile memory 204 stores the data. To do so, the TCQ logic 230 may reference the memory array 252 (e.g., using a set of the memory address bits) to determine whether one or more of the n sets of volatile memory cells associated with the memory address stores the requested data. If the requested data is stored in the volatile memory 204, the interface controller 202 may transfer the requested data to the buffer 218 for transmission to the host device over the data bus 260.

If the requested data is not stored in the volatile memory 204, the interface controller 202 may retrieve the data from the non-volatile memory 206 and transfer the data to the buffer 218 for transmission to the host device over the data bus 260. Additionally, the interface controller 202 may transfer the requested data from the buffer 218 to the volatile memory 204 so that the data can be accessed with a lower latency during a subsequent retrieval operation. Before transferring the requested data, however, the interface controller 202 may first determine whether one or more of the n associated sets of volatile memory cells are available to store the requested data. The interface controller 202 may determine the availability of the n associated sets of volatile memory cells by communicating with the related cache management circuit set. If an associated set of volatile memory cells is available, the interface controller 202 may transfer the data in the buffer 218 to the volatile memory 204 without performing an eviction process. Otherwise, the interface controller 202 may transfer the data from the buffer 218 to the volatile memory 204 after performing an eviction process.

The memory subsystem 200 may be implemented in one or more configurations, including one-chip versions and multi-chip versions. A multi-chip version may include one or more constituents of the memory subsystem 200, including the interface controller 202, the volatile memory 204, and the non-volatile memory 206 (among other constituents or combinations of constituents), on a chip that is separate from a chip that includes one or more other constituents of the memory subsystem 200. For example, in one multi-chip version, respective separate chips may include each of the interface controller 202, the volatile memory 204, and the non-volatile memory 206. In contrast, a one-chip version may include the interface controller 202, the volatile memory 204, and the non-volatile memory 206 on a single chip.

Although the use of multiple memories, such as the volatile memory 204 and the non-volatile memory 206, may provide distinct advantages to a single memory system, the use of multiple memories may have unique challenges unencountered in a single memory system. For example, a host device that wishes to access data in the memory subsystem 200 may not know which memory (e.g., the volatile memory 204, the non-volatile memory 206, another memory not shown) stores the data. To resolve this issue, the memory subsystem 200 may include the TCQ logic 230, which may also be referred to herein as a TCQ complex or a TCQ controller. The TCQ logic 230 may, among other operations, route access commands from the host device to the appropriate memory so that the access commands can be serviced even though the host device may be unaware of which memory should be accessed. Thus, the use of TCQ logic 230 may allow the host device to issue a single access command to the memory subsystem 200, which may reduce the number of commands that must be issued and serviced, conserve power, and reduce required processing resources and bandwidth at the host device, or the memory subsystem 200, or both.

FIG. 3 illustrates an example of a device 300 that supports efficient command scheduling for multiple memories in accordance with examples as disclosed herein. The device 300 may be an example of a memory subsystem or interface controller, among other components, described herein. The device 300 may include TCQ logic 305, which may be an example of the TCQ logic 230 described with reference to FIG. 2. According to the techniques described herein, the TCQ logic 305 may accumulate and manage access commands from, for example, a host device and route the access commands to an appropriate memory of the device 300. For example, the TCQ logic 305 may route an access command to a volatile memory coupled with the device 300 or a non-volatile memory coupled with the device 300, among other memories. In some examples, the access command may be routed to the appropriate memory via a respective scheduler coupled with the memory.

Although the functionality described herein may be attributed to various components for illustration, it should be appreciated that some functionality described herein may be distributed, or shared between components, or attributed to components other than in the manner described.

The TCQ logic 305 may be coupled with one or more command decoders 325, which may be examples of the decoder 228 described with reference to FIG. 2. The command decoder 325 may receive access commands from a host device coupled with the device 300 and communicate the access commands to the TCQ logic 305. An access command may refer to a command or request that prompts an operation in a memory (an activation operation, a read operation, a write operation, a pre-charge operation, etc.). The TCQ logic may also be coupled with one or more read buffer(s) 345 and/or write buffer(s) 340. The read buffers 345 may be storage components (e.g., memory arrays or sub-arrays) that store data that has been read from the volatile memory or the non-volatile memory and that is intended for an intermediary buffer (e.g., a buffer 218). The write buffers 340 may be storage components that store data (e.g., from an intermediary buffer, such as a buffer 218) that is to be written to the volatile memory or the non-volatile memory.

The TCQ logic 305 may manage one or more access commands received from the host device. For example, the TCQ logic 305 may control the storage, ordering, and issuance of access commands for in-order operation or out-of-order operation (or some combination). In-order operation may refer to a mode of operation in which the device 300 satisfies access commands in the order of receipt from the host device. Out-of-order operation may refer to a mode of operation in which the device 300 is permitted to satisfy access commands in a different order than the order of receipt from the host device. Satisfaction of an access command may refer to completion of the action indicated by the access command, whereas servicing an access command may refer to one or more initial or intermediate operations performed in the process of satisfying the access command. In the context of a read command, for example, satisfaction of the read command may refer to the return of data requested by the read command to the requesting device (e.g., a host device), whereas servicing of the read command may refer to one or more operations performed to satisfy the read command.

To manage access commands from the host device, the TCQ logic 305 may include a memory array 330 and processing circuitry 335. The memory array 330 may be an example of the memory array 250 described with reference to FIG. 2 and the processing circuitry 335 may be an example of the processing circuitry 262 described with reference to

FIG. 2. The memory array 330 may be a register, buffer, or other storage component capable of being operated as a queue. The processing circuitry 335 may be, or include, a logic circuit and/or processor and may be characterized, in some examples, as a finite state machine (FSM). For instance, the processing circuitry 335 may be a finite state machine that is implemented in hardware or software. The processing circuitry 335 may save access commands issued by the host device in the memory array 330, update entries in the memory array 330 that provide information about the access commands, and issue access commands stored in the memory array 330 in accordance with the entries. In some examples, the TCQ logic 305 may be referred to as transaction processing management logic or a central processing block, among other suitable terminology.

As noted, the TCQ logic 305 may store access commands and information associated with the access commands in the memory array 330. The memory array 330 may include multiple fields each with N entries. Each entry may be fully searchable and editable by the processing circuitry 335. For example, each entry in the memory array 330 may be independently accessed and updated by the processing circuitry 335, which may allow the device 300 to reduce power consumption and latency relative to other access techniques.

The processing circuitry 335 may reference the entries of the memory array 330 to organize, order, and/or issue access commands to schedulers (or “scheduling components”) for different memories. For example, the processing circuitry 335 may issue access commands to the non-volatile memory (“NVM”) scheduler 310, the volatile memory (“VM”) scheduler 315, and the buffer scheduler 320. The non-volatile memory scheduler 310 may be an example of the scheduler 248-a and may issue access commands for a non-volatile memory coupled with the device 300. The volatile memory scheduler 315 may be an example of the scheduler 248-b and may issue access commands for a volatile memory coupled with the device 300. And the buffer scheduler 320 may issue access command for a buffer (such as a buffer 218, as described with reference to FIG. 2) coupled with the TCQ logic 305. Each scheduler may be (or include) a circuit, logic, a controller, a processor, etc. capable of performing the functions described herein.

In some examples, the memory array 330 may include a Schedule_To (“Sched_To) field. An entry in the Schedule_To field may indicate the memory to which a corresponding access command is assigned or allocated. For example, an entry in the Schedule_To field may indicate that a corresponding access command is assigned to the volatile memory (“VM”), the non-volatile memory (“NVM”), or the buffer (“BUF”). Put another way, the processing circuitry 335 may indicate the destination memory (or “target” memory) for an access command. By referencing the Schedule_To entry for an access command, the processing circuitry 335 may identify the memory targeted for the access command and issue the access command to the appropriate scheduler.

The Schedule_To field may be updated after the processing circuitry 335 determines which memory should service the access command. When an access command is received at the processing circuitry 335, the processing circuitry 335 may not know which memory should service the command. For example, the processing circuitry 335 may not know whether the volatile memory should be used to service the access command (e.g., in the event of a cache hit), or whether the non-volatile memory should be used to service the access command (e.g., in the event of a cache miss). So, the processing circuitry 335 may update the Schedule_To field for an access command after determining which memory should be used to service the access command (e.g., after determining a cache hit or miss).

Thus, the processing circuitry 335 may assign access commands from the host device to the volatile memory, the non-volatile memory, or the buffer coupled with the device 300. As noted, the buffer may be an example of the buffer 218 and thus the buffer may act as an intermediary buffer that relays data associated with access commands between the host device, the volatile memory, and the non-volatile memory. Because satisfying an access command for the volatile memory or the non-volatile memory may involve use of the buffer to relay data, the processing circuitry 335 may be configured to generate access commands for the buffer (in addition to routing access commands from the host device to the buffer). The access commands generated for the buffer may be based on responses from the volatile memory and the non-volatile memory.

In some examples, the memory array 330 may include a transaction identifier (TID) field. The entries in the TID field may store TIDs, which may be unique bit values that indicate the identities of respective access commands and distinguish the access commands from other access commands. The processing circuitry 335 may update an entry in the TID field when an access command is added to the storage component 440. The processing circuitry 335 may issue access commands for a memory in order of their associated TIDs unless a hazard is encountered or an associated entry in the Next-TID field indicates a different order.

The entries in the Next-TID field may indicate the TID of the next access command to be issued by the TCQ logic 305. The Next-TID field may allow the TCQ logic 305 to modify the order of issuance for access commands that are received from the host device out of order. For example, as illustrated in FIG. 3, instead of executing the access commands in order of their TIDs, the device 300 may issue the access command associated with TID 0, then the access command associated with TID 3, then the access command associated with TID 5, and then the access command associated with TID 7. In some examples, the processing circuitry 335 may use the Next-TID entries to build, for each bank of a memory, a list linking the access commands to be performed in order. The list may be referred to as a per-bank linkage list. In some examples, the processing circuitry 335 may order access commands for an open row in a bank so that the access commands are issued in order of receipt from the host device (e.g., the processing circuitry 335 may create a chain of Next_TIDs for the open row). However, the processing circuitry 335 may order access commands for different row so that the access commands are issued out of order (with regards to receipt from the host device).

In some examples, the memory array 330 may include a Valid field (or “validity” field). The entries in the Valid field may indicate whether one or more corresponding entries in the memory array 330 are valid or invalid. For example, the entry in the Valid field for an access command may indicate whether a corresponding TID entry is valid. A TID is valid if it represents an access command stored in the memory array 330. A TID is invalid if it is a random value unassociated with an access command stored in the memory array 330. Thus, the TID entries may prevent the TCQ logic 305 from issuing random or meaningless commands. In the illustrated example, a logic ‘1’ may indicate a valid TID and a logic ‘0’ may indicate an invalid TID. However, other implementations are contemplated.

The processing circuitry 335 may update an entry in the Valid field when a TID is added to the storage component 440. So, in some examples, the memory array 330 may include invalid TIDs upon start-up or initialization, and the quantity of invalid TIDs may be reduced as more TID entries are updated to represent access commands.

In some examples, the memory array 330 may include a Want_Issue field. An entry in the Want_Issue field may indicate the ready status of access command associated with that entry. In the illustrated example, a logic ‘1’ may indicate that an access command is ready to be issued and a logic ‘0’ may indicate that an access command is not ready to be issued. However, other implementations are contemplated. The processing circuitry 335 may update an entry in the Want_Issue field after determining whether a hazard is detected or after determining that a detect hazard has been resolved, among other triggers.

In some examples, the memory array 330 may include a Command (“CMD”) Type field. An entry in the Command Type field may indicate the type of access command associated with that entry. Example types of commands include activate (“ACT”) commands, read (“RD”) commands (including read 16B (“RD16”) commands and read 32B (“RD32”) commands), write (“WR”) commands (including write 32B (“WR32”) commands and write 64B (“WR64”) commands), mode register write (MRW) commands, column access strobe (CAS) commands, and/or pre-charge (PRE) commands, among others. Thus, the processing circuitry 335 may know which type of command to issue based on the Command Type entry for a TID. In some examples, a Command Type entry for an access command may be referred to as an indication of the access command.

An activate command may be a command to activate (or “open”) one or more rows of a memory. Activating a row may involve applying an activation voltage to the access line associated with the row so that the row can be accessed during a subsequent read command or write command. A read command may be a command to read a set of memory cells in a row. Reading a set of memory cells may involve sensing the logic states of the memory cells to determine the data stored in the memory cells. A write command may be a command to write data to a set of memory cells in a row. Writing data to a set of memory cells may involve altering the logic states stored by the memory cells so as to represent the data. A mode register write command may be a command that modifies the contents of a register in the device 300. A column access strobe command maybe a command that causes data sensed from columns of a row to be transferred from sense components to a data bus for communication to another component of the device 300. A pre-charge command may be a command to pre-charge a row. Pre-charging a row may also be referred to as deactivating or closing a row and may involve removing an activation voltage from the access line associated with the row and/or latching data sensed from the row.

In some examples, the memory array 330 may include one or more address fields. For instance, the memory array 330 may include a host device address (“HD Addr.”) field, a Way ID address field, and a non-volatile memory address (“NVM Addr.”) field.

An entry in the host device address field may indicate a logical address targeted by an access command associated with the entry. In some examples, the logical address may be represented by thirty (30) bits, as illustrated in FIG. 3. The device 300 may translate the logical address to a physical address for the non-volatile memory. Thus, the logical address of an access command may be associated with a non-volatile memory address. A logical address may be a virtual address generated by the host device and used to reference a location where data is expected to be stored, whereas a physical address may be an actual address that identifies a physical location where data is actually stored.

An entry in the non-volatile memory address field may indicate the non-volatile memory address associated with the access command for that entry. As noted, the non-volatile memory address may be determined based on the logical address (e.g., the TCQ logic 305 may translate the logical address into an actual address that indicates a physical location in the non-volatile memory). In some examples, the non-volatile memory address may be represented by thirty (30) bits, as illustrated in FIG. 3. In an n-way set associative addressing scheme, each non-volatile memory address may be associated with a set of n volatile memory rows as described with reference to FIG. 2.

An entry in the Way ID field may indicate a row of the volatile memory associated with the non-volatile memory address. As noted with reference to FIG. 2, there may be n rows of volatile memory associated with a given non-volatile memory address. For example, in a 16-way set-associative cache system, there may be sixteen (16) rows of volatile memory that are permitted to stored data for a particular non-volatile memory address. In such an example, the row that stores the data for the non-volatile memory address may be indicated by the Way ID, which may be represented by four (4) bits.

In some examples, the memory array 330 may include a WR Data Buffer. An entry in the WR Data Buffer field for a write command may indicate which write buffer 340 has data associated with the write command, or which data in a write buffer 340 is the data associated with the write command. Thus, the processing circuitry 335 may use a WR Data Buffer entry to determine which data buffered at a write buffer 340 belongs to a write command. In some examples, each entry in the WR Data Buffer field may include a validity bit (denoted “V”) that indicates whether the entry is valid or invalid.

In some examples, the memory array 330 may include a read identifier (RID) field. An entry in the RID field for a read command may indicate the identifier assigned to a read command. In some examples, the device 300 may use the RID of a read command to determine which read buffer 345 has the data associated with the read command, or which data in a read buffer 345 has the data associated with the read command.

In some examples, the memory array 330 may include a Hazard field. An entry in the Hazard field may indicate that issuance of the access command associated with entry will result (e.g., due to a timing conflict) in an error (e.g., return of, or storage of, incorrect data) unless precautions are taken. Such a phenomenon may be referred to as a hazard condition. Thus, the entry for the Hazard field of an access command may indicate various hazard conditions that arise from servicing the access command in order of receipt, in accordance with default timing parameters, or both.

In one example, the hazard condition may be a Write after Write (WaW) hazard that occurs when servicing one write command in a default manner will violate timing parameters for servicing a previous write command. In another example, the hazard condition may be a Read after Write (RaW) hazard that occurs when servicing a read command in a default manner will result in the wrong data being read from memory (e.g., because the read command is issued before the write command is satisfied). In another example, the hazard condition may be a Write after Read (WaR) hazard that occurs when servicing a write command in a default manner will violate timing parameters for servicing a previous read command. To resolve or avoid a hazard condition, the processing circuitry 335 may delay issuance of an access command, or re-order one or more access commands, to comply with the timing parameters of the memories. In some examples, the memory array 330 may include a hazard link TID (“HZD_Link_TID) field. An entry in the hazard link TID field may indicate the TID of the next access command to be issued so that a hazard can be avoided.

In some examples, the memory array 330 may include a Starvation Counter field. An entry in the Starvation Counter field for an access command may indicate the age of the access command (e.g., the amount of time the access command has been in the queue of the memory array 330) so that ignored access commands can be prioritized for issuance. In some examples, the memory array 330 may include a Skip field. An entry in the Skip field for an access command may indicate whether that access command should be skipped (e.g., not issued). In some examples, the memory array 330 may include a Prefetch field. An entry in the Prefetch field for an access command may indicate whether a prefetch should be performed for the access command. In some examples, the memory array 330 may include a Way ID Check field. An entry in the Way ID Check field for an access command may indicate whether the Way ID for that access command is valid.

Thus, the memory array 330 may include various fields that assist the processing circuitry 335 with the management and issuance of access commands for multiple memories.

FIG. 4 illustrates an example of a process flow 400 that supports efficient command scheduling for multiple memories in accordance with examples as disclosed herein. Process flow 400 may be implemented by an interface controller 115 as described with reference to FIG. 1, an interface controller 202 as described with reference to FIG. 2, or a device 300 as described with reference to FIG. 3. For ease of reference, the process flow 400 is described with reference to the device 300. For example, aspects of the process flow 400 may be implemented by the TCQ logic 305, among other components. Additionally or alternatively, aspects of the process flow 400 may be implemented as instructions stored in memory (e.g., firmware stored in the volatile memory 120 and/or the non-volatile memory 125). For example, the instructions, when executed by a controller, may cause the controller to perform the operations of the process flow 400.

Alternative examples of the process flow 400 may be implemented in which some operations are performed in a different order than described or are not performed at all. In some cases, operations may include features not mentioned below, or additional operations may be added.

At 405, an access command may be received. For example, the TCQ logic 305 may receive an access command from a host device. The access command may be associated with a host device address (e.g., a logical address). At 410, the access command, or an indication of the access command, may be stored in a queue. For example, the TCQ logic 305 may store the access command (or an indication of the access command) in a queue of the memory array 330. In some examples, the TCQ logic may also store the host device address for the access command, for example, in the host device address field entry for the access command.

At 415, a non-volatile memory address associated with the access command may be determined and a Way ID associated with the non-volatile memory address may be determined. For example, the TCQ logic 305 may determine the non-volatile memory address associated with the access command and the Way ID associated with the non-volatile memory address.

At 420, one or more field entries associated with the access command may be updated. For example, the TCQ logic 305 may update in the queue one or more field entries for the access command. For example, the TCQ logic 305 may update the non-volatile memory address field entry for the access command to reflect the non-volatile memory address determined at 415. Similarly, the TCQ logic 305 may update the Way ID field entry for the access command to reflect the Way ID determined at 415. Additionally or alternatively, the TCQ logic 305 may update the TID field entry for the access command, the Valid field entry for the access command, the Next TID field entry for the access command, the command type field entry for the access command, the Hazard field entry for the access command, and/or other relevant field entries for the access command.

At 425, a volatile memory hit or miss may be determined. For example, the TCQ logic 305 may determine whether there is a volatile memory hit or a volatile memory miss for the access command. A volatile memory hit may refer to a read hit or a write hit, among other scenarios, and a volatile memory miss may refer to a read miss or a write miss, among other scenarios.

A read hit may occur when data requested by the access command (e.g., a read command) is stored in the volatile memory. A read miss may occur when data requested by the access command (e.g., a read command) is absent from the volatile memory. So, the TCQ logic 305 may determine a read hit or miss based on the location of data requested by the read command. The TCQ logic 305 may determine the location of requested data by translating the logical address associated with the read command to a non-volatile memory address, determining the n rows of volatile memory rows associated with the non-volatile memory address, and referencing the tag information for the n rows to determine the non-volatile memory addresses with data stored in the n rows.

A write hit may occur when the volatile memory stores data from the non-volatile memory address targeted by the access command (e.g., a write command). A write miss may occur when the volatile memory does not store data from the non-volatile memory address targeted by the access command (e.g., a write command). So, the TCQ logic 305 may determine a write hit or miss based on the location of data targeted by the write command. The TCQ logic 305 may determine the location of targeted data (e.g., data targeted to be over-written) by translating the logical address associated with the read command to a non-volatile memory address, determining the n rows of volatile memory rows associated with the non-volatile memory address, and referencing the tag information for the n rows to determine the non-volatile memory addresses with data stored in the n rows.

The TCQ logic 305 may determine whether there is a volatile memory hit or miss to determine the appropriate destination for the access command, which may not be directly indicated by the access command. For example, the access command may include information for satisfying the access command (e.g., a logical address, command type, amount of data) but not information on which memory should be used to service the access command. Thus, the TCQ logic 305 may be responsible for selecting the appropriate memory to service the access command based on whether the access command results in a volatile memory hit or miss. Because the TCQ logic 305 routes an access command to the appropriate memory, the host device may avoid transmitting the access command to both memories, which may save power and processing resources.

If at 425, a volatile memory miss is determined, the Sched_To field entry for the access command may be updated to indicate the non-volatile memory. For example, if, at 425, the TCQ logic 305 determines that there is a volatile memory miss, the TCQ logic 305 may, at 430, update in the queue the Sched_To field entry for the access command to indicate the non-volatile memory. Thus, the TCQ logic may select the non-volatile memory to service the access command. If, at 425, a volatile memory hit is determined, the Sched_To field entry for the access command may be updated to indicate the volatile memory For example, if, at 425, the TCQ logic 305 determines that there is a volatile memory hit, the TCQ logic 305 may, at 435, update in the queue the Sched_To field entry for the access command to indicate the volatile memory. Thus, the TCQ logic may select the volatile memory to service the access command.

At 440, the presence of a hazard condition may be determined. For example, the TCQ logic 305 may determine whether the Hazard field entry for the access command indicates a hazard condition. If, at 440, the Hazard field entry for the access command indicates a hazard condition, the issuance of the access command may be delayed or stalled a threshold duration of time or until the hazard condition has been resolved.

For example, if, at 440, the TCQ logic 305 determines that the Hazard field entry for the access command indicates a hazard condition, the TCQ logic may, at 445, delay or stall for a threshold duration of time or until the hazard condition has been resolved. The TCQ logic 305 may then, at 450, issue the access command to the scheduler for the memory indicated by the Sched_To field entry for the access command.

If, at 440, the Hazard field entry for the access command does not indicate a hazard condition, the access command may be issued without delay (e.g., according to a default timing). For example, if, at 440, the TCQ logic 305 determines that the Hazard field entry for the access command does not indicate a hazard condition, the TCQ logic may, at 450, issue the access command to the scheduler for the memory indicated by the Sched_To field entry for the access command. The issuance of the access command may occur according to a default timing and without the delay at 445.

In some examples, one or more access commands for an intermediate buffer may be generated at 455. For example, the TCQ logic 305 may, at 455, generate one or more access commands for a buffer (e.g., a buffer 218) so that data associated with the access command received at 405 can be communicated to the appropriate destination. For example, if a write command is received at 405, the TCQ logic 305 may generate one or more commands for the buffer so that data provided by the host device is relayed from the buffer to the volatile memory and/or the non-volatile memory. Or, if a read command is received at 405, the TCQ logic 305 may generate one or more commands for the buffer so that data requested by the host device is relayed from the buffer to the host device. Relaying data via the buffer may involve communicating the data to or from local buffers (e.g., read buffer(s) 345, write buffers 340). At 460, the one or more access commands generated at 455 may be issued. For example, the TCQ logic 305 may issue the one or more access commands generated at 455 to the buffer scheduler 320.

Thus, the TCQ logic 305 may manage access commands for multiple memories.

FIG. 5 shows a block diagram 500 of a device 505 that supports efficient command scheduling for multiple memories in accordance with examples as disclosed herein. The device 505 may be an example of aspects of a memory subsystem 110, memory subsystem 200, interface controller 202, TCQ logic 230, device 300, or TCQ logic 305 as described herein. Thus, the device 505 may be coupled with a host device, a volatile memory, a non-volatile memory, and a buffer. The device 505 may include a reception component 510, a selection component 515, a communication component 520, a cache management component 525, and a queue management component 530. Each of these modules may include circuitry configured to perform the functions described herein. Each of these modules may communicate, directly or indirectly, with one another (e.g., via one or more buses or other conductive connections).

In a first example, the reception component 510 receive an access command from a host device. The reception component 510 may be a bus interface or other component capable of performing the functions described herein. The selection component 515 may select, from a combination of memory media based at least in part on the access command, one of the buffer, the volatile memory, or the non-volatile memory to service the access command. The selection component 515 may be or include logic, circuitry, a processor, a controller, or other components capable of performing the functions described herein. The communication component 520 may communicate the access command to the buffer, the volatile memory, or the non-volatile memory selected from the combination of the memory media. The communication component 520 may be a bus interface or other component capable of performing the functions described herein.

In some examples, the reception component 510 may receive a second access command from the host device. In some examples, the selection component 515 may select the buffer, the volatile memory, or the non-volatile memory to service the second access command, wherein the memory medium selected to service the second access command is different than the memory medium selected to service the access command.

In some examples, the communication component 520 may communicate the access command to a first scheduler for the memory medium selected to service the access command. In some examples, the communication component 520 may communicate the second access command to a second scheduler for the memory medium selected to service the second access command.

In some examples, the access command is associated with an address. In some examples, the cache management component 525 may determine, based at least in part on the address, that data associated with the access command is stored in the volatile memory, where the volatile memory is selected to service the access command based at least in part on the determination. The cache management component 525 may be or include logic, circuitry, a processor, a controller, or other components capable of performing the functions described herein.

In some examples, the access command is associated with an address. In some examples, the cache management component 525 may determine, based at least in part on the address, that data associated with the access command is absent from the volatile memory, wherein the non-volatile memory is selected to service the access command based at least in part on the determination.

In some examples, the access command is a read command. In some examples, the queue management component 530 may determine, after communicating the read command to the selected memory medium, that data requested by the read command is buffered at a local buffer. The queue management component 530 may be or include logic, circuitry, a processor, a controller, or other components capable of performing the functions described herein. In some examples, the queue management component 530 may generate, based at least in part on the determination, one or more access commands to communicate the data from the local buffer to the buffer for relay to the host device.

In some examples, the access command is a write command associated with a non-volatile memory address. In some examples, the cache management component 525 may determine, based at least in part on the non-volatile memory address, that a row of the volatile memory associated with the non-volatile memory address stores data from the non-volatile memory address, wherein the volatile memory is selected to service the write command.

In some examples, the access command is a write command associated with a non-volatile memory address. In some examples, the cache management component 525 may determine, based at least in part on the non-volatile memory address, that data stored at the non-volatile memory address in the non-volatile memory is absent from the volatile memory, wherein the non-volatile memory is selected to service the write command.

In some examples, the access command is a write command. In some examples, the queue management component 530 may determine that data associated with the write command is buffered at the buffer. In some examples, the queue management component 530 may generate, based at least in part on the determination, one or more access commands to communicate the data from the buffer to a local buffer for relay to the volatile memory or the non-volatile memory.

In a second example, the reception component 510 may receive an access command from a host device. The queue management component 530 may store the access command (or an indication of the access command) in a queue of a memory array maintained by the processing circuitry. The queue management component 530 may update, in the queue, an entry associated with the access command to indicate that the access command is for the non-volatile memory or the volatile memory. The communication component 520 may issue the access command to the non-volatile memory or the volatile memory based at least in part on the entry in the queue.

In some examples, the queue management component 530 may determine, in response to the access command, data stored in the volatile memory, wherein the entry is updated based at least in part on the data stored in the volatile memory.

In some examples, the reception component 510 may receive a second access command from the host device. In some examples, the queue management component 530 may store the second access (or an indication of the second access command) command in the queue. In some examples, the queue management component 530 may update, in the queue, a second entry associated with the second access command to indicate that the second access command is for the non-volatile memory or the volatile memory.

In some examples, the queue management component 530 may determine that servicing the access command and the second access command in order of receipt, according to a default timing, or a combination thereof, will result in an error. In some examples, the queue management component 530 may update, for a hazard field in the queue, a third entry associated with the access command to indicate the determination. In some examples, the communication component 520 may delay, based at least in part on the third entry, issuance of the access command until a threshold amount of time has expired or the second access command has been serviced.

In some examples, the queue management component 530 may update, in the queue, a second entry associated with the access command based at least in part on receiving the access command. In some examples, the second entry is for a validity field that indicates that entries for one or more other fields associated with the access command are valid. In some examples, the second entry is for a write identifier field that indicates data in a buffer to be written to the non-volatile memory or the volatile memory. In some examples, the second entry is for a transaction identifier field, the second entry indicating an order of receipt for the access command relative to other access commands stored in the queue. In some examples, the queue management component 530 may update, in the queue, a third entry associated with the access command, the third entry comprising a second transaction identifier field that indicates a second transaction identifier associated with a second access command to be issued after the access command is issued.

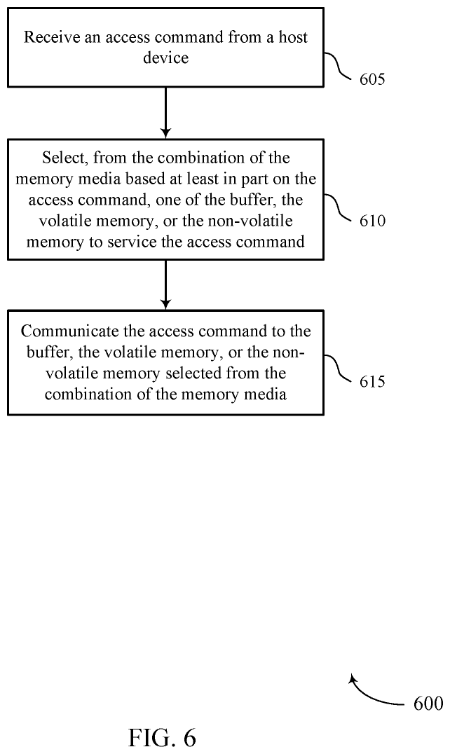

FIG. 6 shows a flowchart illustrating a method or methods 600 that supports efficient command scheduling for multiple memories in accordance with aspects of the present disclosure. The operations of method 600 may be implemented by a memory subsystem or its components as described herein. For example, the operations of method 600 may be performed by a memory subsystem as described with reference to FIGS. 1 and 2. In some examples, a memory subsystem may execute a set of instructions to control the functional elements of the memory subsystem to perform the described functions. Additionally or alternatively, a memory subsystem may perform aspects of the described functions using special-purpose hardware.

In some examples, the operations of method 600 may be implemented by an apparatus that includes logic coupled with memory media. A combination of the memory media may include a buffer, a volatile memory, and a non-volatile memory. The logic may be operable to cause the apparatus to perform the operations of method 600.

At 605, the method may include receiving an access command from a host device. The operations of 605 may be performed according to the methods described herein. In some examples, aspects of the operations of 605 may be performed by a reception component as described with reference to FIG. 5.

At 610, the method may include selecting, from the combination of the memory media based at least in part on the access command, one of the buffer, the volatile memory, or the non-volatile memory to service the access command. The operations of 610 may be performed according to the methods described herein. In some examples, aspects of the operations of 610 may be performed by a selection component as described with reference to FIG. 5.

At 615, the method may include communicating the access command to the buffer, the volatile memory, or the non-volatile memory selected from the combination of the memory media. The operations of 615 may be performed according to the methods described herein. In some examples, aspects of the operations of 615 may be performed by a communication component as described with reference to FIG. 5.

In some examples, an apparatus as described herein may perform a method or methods, such as the method 600. The apparatus may include logic that is operable to cause the apparatus to perform the techniques described herein and that is coupled with memory media, a combination of the memory media comprising a buffer, a volatile memory, and a non-volatile memory. The apparatus may include features, means, or instructions (e.g., a non-transitory computer-readable medium storing instructions executable by a processor) for receiving an access command from a host device; selecting, from the combination of the memory media based at least in part on the access command, one of the buffer, the volatile memory, or the non-volatile memory to service the access command; and communicating the access command to the buffer, the volatile memory, or the non-volatile memory selected from the combination of the memory media.

Some examples of the method 600 and the apparatus described herein may further include operations, features, means, or instructions for receiving a second access command from the host device. Some examples of the method 600 and the apparatus described herein may further include operations, features, means, or instructions for selecting the buffer, the volatile memory, or the non-volatile memory to service the second access command, wherein the memory medium selected to service the second access command is different than the memory medium selected to service the access command.

Some examples of the method 600 and the apparatus described herein may further include operations, features, means, or instructions for communicating the access command to a first scheduler for the memory medium selected to service the access command. Some examples of the method 600 and the apparatus described herein may further include operations, features, means, or instructions for communicating the second access command to a second scheduler for the memory medium selected to service the second access command.

In some examples of the method 600 and the apparatus described herein, the access command is associated with an address. Some examples of the method 600 and the apparatus described herein may further include operations, features, means, or instructions for determining, based at least in part on the address, that data associated with the access command is stored in the volatile memory, wherein the volatile memory is selected to service the access command based at least in part on the determination.

In some examples of the method 600 and the apparatus described herein, the access command is associated with an address. Some examples of the method 600 and the apparatus described herein may further include operations, features, means, or instructions for determining, based at least in part on the address, that data associated with the access command is absent from the volatile memory, wherein the non-volatile memory is selected to service the access command based at least in part on the determination.

In some examples of the method 600 and the apparatus described herein, the access command is a read command. Some examples of the method 600 and the apparatus described herein may further include operations, features, means, or instructions for determining, after communicating the read command to the selected memory medium, that data requested by the read command is buffered at a local buffer coupled with the logic. Some examples of the method 600 and the apparatus described herein may further include operations, features, means, or instructions for generating, based at least in part on the determination, one or more access commands to communicate the data from the local buffer to the buffer for relay to the host device.

In some examples of the method 600 and the apparatus described herein, the access command is a write command associated with a non-volatile memory address. Some examples of the method 600 and the apparatus described herein may further include operations, features, means, or instructions for determining, based at least in part on the non-volatile memory address, that a row of the volatile memory associated with the non-volatile memory address stores data from the non-volatile memory address, wherein the volatile memory is selected to service the write command.

In some examples of the method 600 and the apparatus described herein, the access command is a write command associated with a non-volatile memory address. Some examples of the method 600 and the apparatus described herein may further include operations, features, means, or instructions for determining, based at least in part on the non-volatile memory address, that data stored at the non-volatile memory address in the non-volatile memory is absent from the volatile memory, wherein the non-volatile memory is selected to service the write command.

In some examples of the method 600 and the apparatus described herein, the access command is a write command. Some examples of the method 600 and the apparatus described herein may further include operations, features, means, or instructions for determining that data associated with the write command is buffered at the buffer. Some examples of the method 600 and the apparatus described herein may further include operations, features, means, or instructions for generating, based at least in part on the determination, one or more access commands to communicate the data from the buffer to a local buffer for relay to the volatile memory or the non-volatile memory.

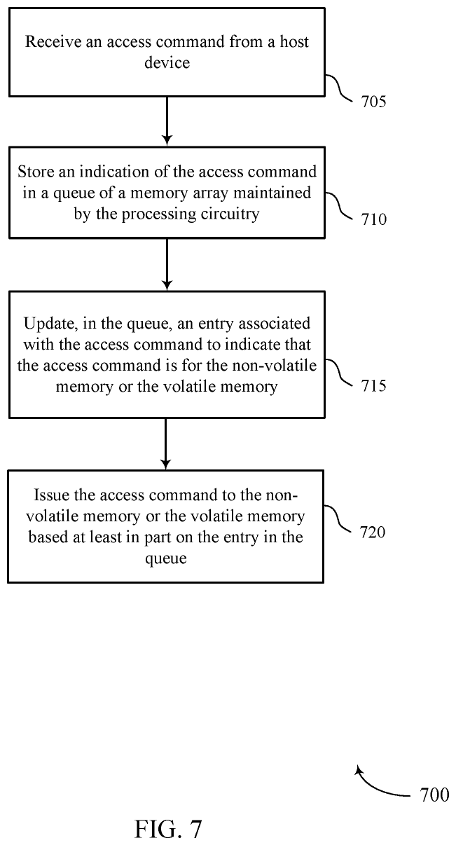

FIG. 7 shows a flowchart illustrating a method or methods 700 that supports efficient command scheduling for multiple memories in accordance with aspects of the present disclosure. The operations of method 700 may be implemented by a memory subsystem or its components as described herein. For example, the operations of method 700 may be performed by a memory subsystem as described with reference to FIGS. 1 and 2. In some examples, a memory subsystem may execute a set of instructions to control the functional elements of the memory subsystem to perform the described functions. Additionally or alternatively, a memory subsystem may perform aspects of the described functions using special-purpose hardware.

In some examples, the operations of method 700 may be implemented by an apparatus that includes a non-volatile memory, a volatile memory configured to operate as a cache for the non-volatile memory, and processing circuitry coupled with the non-volatile memory and the volatile memory. The processing circuitry may be operable to cause the apparatus to perform the operations of method 700.

At 705, the method may include receiving an access command from a host device. The memory address may be associated with a set of memory cells in a bank of the volatile memory. The operations of 705 may be performed according to the methods described herein. In some examples, aspects of the operations of 705 may be performed by a reception component as described with reference to FIG. 5.

At 710, the method may include storing an indication of the access command in a queue of a memory array maintained by the processing circuitry. The operations of 710 may be performed according to the methods described herein. In some examples, aspects of the operations of 710 may be performed by a queue management component as described with reference to FIG. 5.

At 715, the method may include updating, in the queue, an entry associated with the access command to indicate that the access command is for the non-volatile memory or the volatile memory. The operations of 715 may be performed according to the methods described herein. In some examples, aspects of the operations of 715 may be performed by a queue management component as described with reference to FIG. 5.

At 720, the method may include issuing the access command to the non-volatile memory or the volatile memory based at least in part on the entry in the queue. The operations of 720 may be performed according to the methods described herein. In some examples, aspects of the operations of 720 may be performed by a communication component as described with reference to FIG. 5.

In some examples, an apparatus as described herein may perform a method or methods, such as the method 700. The apparatus may include a non-volatile memory; a volatile memory configured to operate as a cache for the non-volatile memory; and processing circuitry that is coupled with the non-volatile memory and the volatile memory and that is operable to cause the apparatus to perform the techniques described herein. The apparatus may include features, means, or instructions (e.g., a non-transitory computer-readable medium storing instructions executable by a processor) for receiving an access command from a host device; storing the access command (or an indication of the access command) in a queue of a memory array maintained by the processing circuitry; updating, in the queue, an entry associated with the access command to indicate that the access command is for the non-volatile memory or the volatile memory; and issuing the access command to the non-volatile memory or the volatile memory based at least in part on the entry in the queue.

Some examples of the method 700 and the apparatus described herein may further include operations, features, means, or instructions for determining, in response to the access command, data stored in the volatile memory, wherein the entry is updated based at least in part on the data stored in the volatile memory.

Some examples of the method 700 and the apparatus described herein may further include operations, features, means, or instructions for receiving a second access command from the host device. Some examples of the method 700 and the apparatus described herein may further include operations, features, means, or instructions for storing the second access command (or an indication of the second access command) in the queue. Some examples of the method 700 and the apparatus described herein may further include operations, features, means, or instructions for updating in the queue, a second entry associated with the second access command to indicate that the second access command is for the non-volatile memory or the volatile memory.

Some examples of the method 700 and the apparatus described herein may further include operations, features, means, or instructions for determining that servicing the access command and the second access command in order of receipt, according to a default timing, or a combination thereof, will result in an error. Some examples of the method 700 and the apparatus described herein may further include operations, features, means, or instructions for updating, for a hazard field in the queue, a third entry associated with the access command to indicate the determination. Some examples of the method 700 and the apparatus described herein may further include operations, features, means, or instructions for delaying, based at least in part on the third entry, issuance of the access command until a threshold amount of time has expired or the second access command has been serviced.

Some examples of the method 700 and the apparatus described herein may further include operations, features, means, or instructions for updating, in the queue, a second entry associated with the access command based at least in part on receiving the access command. In some examples of the method 700 and the apparatus described herein, the second entry is for a validity field that indicates that entries for one or more other fields associated with the access command are valid. In some examples of the method 700 and the apparatus described herein, the second entry is for a write identifier field that indicates data in a buffer to be written to the non-volatile memory or the volatile memory. In some examples of the method 700 and the apparatus described herein, the second entry is for a transaction identifier field, the second entry indicating an order of receipt for the access command relative to other access commands stored in the queue. Some examples of the method 700 and the apparatus described herein may further include operations, features, means, or instructions for updating, in the queue, a third entry associated with the access command, the third entry comprising a second transaction identifier field that indicates a second transaction identifier associated with a second access command to be issued after the access command is issued.

It should be noted that the methods described above describe possible implementations, and that the operations and the steps may be rearranged or otherwise modified and that other implementations are possible. Furthermore, portions from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, it will be understood by a person of ordinary skill in the art that the signal may represent a bus of signals, where the bus may have a variety of bit widths.

A protocol may define one or more communication procedures and one or more communication parameters supported for use by a device or component. For example, a protocol may define various operations, a timing and a frequency for those operations, a meaning of various commands or signals or both, one or more addressing scheme(s) for one or more memories, a type of communication for which pins are reserved, a size of data handled at various components such as interfaces, a data rate supported by various components such as interfaces, or a bandwidth supported by various components such as interfaces, among other parameters and metrics, or any combination thereof. Use of a shared protocol may enable interaction between devices because each device may operate in a manner expected, recognized, and understood by another device. For example, two devices that support the same protocol may interact according to the policies, procedures, and parameters defined by the protocol, whereas two devices that support different protocols may be incompatible.

To illustrate, two devices that support different protocols may be incompatible because the protocols define different addressing schemes (e.g., different quantities of address bits). As another illustration, two devices that support different protocols may be incompatible because the protocols define different transfer procedures for responding to a single command (e.g., the burst length or quantity of bytes permitted in response to the command may differ). Merely translating a command to an action should not be construed as use of two different protocols. Rather, two protocols may be considered different if corresponding procedures or parameters defined by the protocols vary. For example, a device may be said to support two different protocols if the device supports different addressing schemes, or different transfer procedures for responding to a command.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to condition of moving from an open-circuit relationship between components in which signals are not presently capable of being communicated between the components over a conductive path to a closed-circuit relationship between components in which signals are capable of being communicated between components over the conductive path. When a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as a n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus, comprising:
logic coupled with memory media, a combination of the memory media comprising a buffer, a volatile memory, and a non-volatile memory, wherein the logic is operable to cause the apparatus to:
receive an access command from a host device;
select, from the combination of the memory media based at least in part on the access command, one of the buffer, the volatile memory, or the non-volatile memory to service the access command; and
communicate the access command to the buffer, the volatile memory, or the non-volatile memory selected from the combination of the memory media.

2. The apparatus of claim 1, wherein the logic is operable to cause the apparatus to:
receive a second access command from the host device;
select the buffer, the volatile memory, or the non-volatile memory to service the second access command, wherein the memory medium selected to service the second access command is different than the memory medium selected to service the access command.

3. The apparatus of claim 2, wherein the logic is operable to cause the apparatus to communicate the access command by being operable to cause the apparatus to:
communicate the access command to a first scheduler for the memory medium selected to service the access command, and wherein the logic is operable to cause the apparatus to:
communicate the second access command to a second scheduler for the memory medium selected to service the second access command.

4. The apparatus of claim 1, wherein the access command is associated with an address, and wherein the logic is operable to cause the apparatus to:
determine, based at least in part on the address, that data associated with the access command is stored in the volatile memory, wherein the volatile memory is selected to service the access command based at least in part on the determination.

5. The apparatus of claim 1, wherein the access command is associated with an address, and wherein the logic is operable to cause the apparatus to:
determine, based at least in part on the address, that data associated with the access command is absent from the volatile memory, wherein the non-volatile memory is selected to service the access command based at least in part on the determination.

6. The apparatus of claim 1, wherein the access command comprises a read command, and wherein the logic is operable to cause the apparatus to:
determine, after communicating the read command to the selected memory medium, that data requested by the read command is buffered at a local buffer coupled with the logic; and
generate, based at least in part on the determination, one or more access commands to communicate the data from the local buffer to the buffer for relay to the host device.

7. The apparatus of claim 1, wherein the access command comprises a write command associated with a non-volatile memory address, and wherein the logic is operable to cause the apparatus to:
determine, based at least in part on the non-volatile memory address, that a row of the volatile memory associated with the non-volatile memory address stores data from the non-volatile memory address, wherein the volatile memory is selected to service the write command.

8. The apparatus of claim 1, wherein the access command comprises a write command associated with a non-volatile memory address, and wherein the logic is operable to cause the apparatus to:
determine, based at least in part on the non-volatile memory address, that data stored at the non-volatile memory address in the non-volatile memory is absent from the volatile memory, wherein the non-volatile memory is selected to service the write command.

9. The apparatus of claim 1, wherein the access command comprises a write command, and wherein the logic is operable to cause the apparatus to:
determine that data associated with the write command is buffered at the buffer; and
generate, based at least in part on the determination, one or more access commands to communicate the data from the buffer to a local buffer for relay to the volatile memory or the non-volatile memory.

10. An apparatus, comprising:
a non-volatile memory;
a volatile memory configured to operate as a cache for the non-volatile memory; and
processing circuitry coupled with the non-volatile memory and the volatile memory, the processing circuitry operable to cause the apparatus to:
receive an access command from a host device;
store an indication of the access command in a queue of a memory array maintained by the processing circuitry;
update, in the queue, an entry associated with the access command to indicate that the access command is for the non-volatile memory or the volatile memory; and
issue the access command to the non-volatile memory or the volatile memory based at least in part on the entry in the queue.

11. The apparatus of claim 10, wherein the processing circuitry is operable to cause the apparatus to:
determine, in response to the access command, data stored in the volatile memory, wherein the entry is updated based at least in part on the data stored in the volatile memory.

12. The apparatus of claim 10, wherein the processing circuitry is operable to cause the apparatus to:
receive a second access command from the host device;
store an indication of the second access command in the queue; and
update, in the queue, a second entry associated with the second access command to indicate that the second access command is for the non-volatile memory or the volatile memory.

13. The apparatus of claim 12, wherein the processing circuitry is operable to cause the apparatus to:
determine that servicing the access command and the second access command in order of receipt, according to a default timing, or a combination thereof, will result in an error; and
update, for a hazard field in the queue, a third entry associated with the access command to indicate the determination.

14. The apparatus of claim 13, wherein the processing circuitry is operable to cause the apparatus to:
delay, based at least in part on the third entry, issuance of the access command until a threshold amount of time has expired or the second access command has been serviced.

15. The apparatus of claim 10, wherein the processing circuitry is operable to cause the apparatus to:
update, in the queue, a second entry associated with the access command based at least in part on receiving the access command.

16. The apparatus of claim 15, wherein the second entry is for a transaction identifier field, the second entry indicating an order of receipt for the access command relative to other access commands stored in the queue.

17. The apparatus of claim 16, wherein the processing circuitry is operable to cause the apparatus to:
update, in the queue, a third entry associated with the access command, the third entry comprising a second transaction identifier field that indicates a second transaction identifier associated with a second access command to be issued after the access command is issued.

18. The apparatus of claim 15, wherein the second entry is for a validity field that indicates that entries for one or more other fields associated with the access command are valid.

19. The apparatus of claim 15, wherein the second entry is for a write identifier field that indicates data in a buffer to be written to the non-volatile memory or the volatile memory.

20. A non-transitory computer-readable medium storing code comprising instructions which, when executed by a processor of an electronic device, cause the electronic device to:
receive an access command from a host device;
select, from memory media based at least in part on the access command, a buffer, a volatile memory, or a non-volatile memory to service the access command; and
communicate the access command to the buffer, the volatile memory, or the non-volatile memory selected from the memory media.
